(19) United States
(12) Patent Application Publication
(10) Pub. No.: US 2022/0204310 A1
(43) Pub. Date: Jun. 30, 2022

(54) CONNECTOR HOUSING STORAGE STRUCTURE AND CONNECTOR COVER STORAGE STRUCTURE

(71) Applicant: SUMITOMO WIRING SYSTEMS, LTD., Mei (JP)

(72) Inventors: Takuma HIBINO, Mie (JP); Harald LUTSCH, Wolfsburg (DE)

(21) Appl. No.: 17/605,319

(22) PCT Filed: Apr. 3, 2020
(86) PCT No.: PCT/JP2020/015420

§ 371 Date: Oct. 21, 2021

(30) Foreign Application Priority Data
Apr. 26, 2019 (JP) 2019-085188

(51) Int. Cl. B65H 75/38; B65H 75/14

(52) U.S. Cl. CPC B65H 75/38; H01R 13/20; B65H 75/14

(57) ABSTRACT

A connector housing storage structure for storing a connector housing constituting a connector member to be provided on an end part of a communication cable includes a first long body and a first reel, the first long body being wound on the first reel, and the first long body includes a plurality of connector housings and a first carrier linking the plurality of connector housings into one. A connector cover storage structure for storing a connector cover constituting a connector member to be provided on an end part of a communication cable includes a second long body and a second reel, the second long body being wound on the second reel, and the second long body includes a plurality of connector covers and a second carrier linking the plurality of connector covers into one.

### TECHNICAL FIELD

The present invention relates to a connector housing storage structure and a connector cover storage structure.

This application claims a priority based on Japanese Patent Application No. 2019-085188 filed on Apr. 26, 2019, the contents of which are hereby incorporated by reference.

### BACKGROUND

In recent years, high communication of e.g. 100 Mbps or faster has been required. A communication cable with connector used in such high-speed communication is disclosed, for example, in Patent Document 1 and the like. The communication cable with connector of Patent Document 1 includes a communication cable having a conductor, and a shield terminal to be mounted on an end part of the communication cable. The shield terminal includes a terminal unit and an outer conductor for shielding electromagnetic waves. The terminal unit includes an inner conductor functioning as a terminal and a dielectric made of synthetic resin and functioning as a connector member.

The connector member includes a connector housing and a connector cover. In the connector housing, the conductor of the communication cable and the terminal are connected. The connector cover covers a connected part of the conductor and the terminal in the housing.

### PRIOR ART DOCUMENT

### Patent Document

Patent Document 1: JP 2018-152174 A

### SUMMARY OF THE INVENTION

### Problems to be Solved

A connector housing storage structure of the present disclosure is a connector housing storage structure for storing a connector housing constituting a connector member to be provided on an end part of a communication cable, and includes a first long body and a first reel, the first long body being wound on the first reel, wherein the first long body includes a plurality of connector housings and a first carrier linking the plurality of connector housings into one.

A connector cover storage structure of the present disclosure is a connector cover storage structure for storing a connector cover constituting a connector member to be provided on an end part of a communication cable, and includes a second long body and a second reel, the second long body being wound on the second reel, wherein the second long body includes a plurality of connector covers and a second carrier linking the plurality of connector covers into one.

### BRIEF DESCRIPTION OF THE DRAWINGS

FIG. 1 is a schematic configuration diagram of a connector housing storage structure according to an embodiment.

FIG. 2 is a partial enlarged view of a first long body provided in the connector housing storage structure of FIG. 1.

FIG. 3 is a schematic configuration diagram of a connector cover storage structure according to a first embodiment.

FIG. 4 is a partial enlarged view of a second long body provided in the connector cover storage structure of FIG. 3.

FIG. 5 is a diagram showing the procedure of arranging terminals in a connector housing of FIG. 1.

FIG. 6 is a partial enlarged view of the first long body provided with the connector housings holding the terminals.

FIG. 7 is a perspective view of the terminal shown in the first embodiment.

FIG. 8 is a perspective view of the terminal of FIG. 7 viewed from an opposite side.

FIG. 9 is a diagram showing the procedure of mounting the connector housing and a connector cover shown in the first embodiment on an end part of a communication cable.

FIG. 10 is a diagram showing the procedure of connecting the terminals and conductors of the communication cable in the connector housing shown in the first embodiment.

FIG. 11 is an exploded perspective view of a communication cable with connector shown in the first embodiment.

### DETAILED DESCRIPTION TO EXECUTE THE INVENTION

### Problem the Invention Seeks to Solve

A connector housing before being mounted on a communication cable is normally stored in a bag. That is, a plurality of connector housings are randomly packed into one bag. However, the connector housings may collide to be damaged in a container, such as during the transportation of the bag. Further, with a conventional storage structure, it is cumbersome to take out the connector housing from the bag such as when the connector housing is mounted on a communication cable. The same about the connector housing can be said also about the connector cover.

One object of the present disclosure is to provide a connector housing storage structure with which a connector housing is hardly damaged during storage and is easily handled, such as at the time of mounting on a communication cable. Another object of the present disclosure is to provide a connector cover storage structure with which a connector cover is hardly damaged during storage and is easily handled, such as at the time of mounting on a connector housing.

### Effects of Present Disclosure

The connector housing storage structure of the present disclosure suppresses the damage of the connector housing during storage. Further, the connector housing storage structure of the present disclosure facilitates the handling of the connector housing, such as at the time of mounting on a connector housing.

The connector cover storage structure of the present disclosure suppresses the damage of the connector cover during storage. Further, the connector cover storage structure of the present disclosure facilitates the handling of the connector cover, such as at the time of mounting on a connector housing.

### Description of Embodiments of Present Disclosure

First, embodiments of the present disclosure are listed and described.

<1> A connector housing storage structure according to an embodiment is a connector housing storage structure for storing a connector housing constituting a connector member to be provided on an end part of a communication cable, and includes a first long body and a first reel, the first long body being wound on the first reel, wherein the first long body includes a plurality of connector housings and a first carrier linking the plurality of connector housings into one.

According to the connector housing storage structure of the embodiment, the connector housings do not fiercely collide with each other during the storage/transportation of the connector housings. This is because the connector housings are held by the first carrier. Therefore, the connector housing storage structure of the embodiment can suppress the damage of the connector housings, such as during storage.

According to the connector housing storage structure of the embodiment, the connector housings can be efficiently supplied to a work location where an operation of mounting the connector housing on the end part of the communication cable is performed. This is because the connector housings can be supplied to the work location only by feeding the first long body from the first reel toward the work location. Further, since the connector housings provided in the first long body are linked by the first carrier, the orientations of the connector housings to be supplied to the work location are aligned. Further, the connector housings linked to the first long body do not fall during a mounting operation of the connector housing. Therefore, the connector housing is easily mounted on the end part of the communication cable.

<2> As one form of the connector housing storage structure according to the embodiment, the plurality of connector housings are linked laterally side by side by the first carrier.

A connector housing is normally provided with an insertion hole into which a terminal is inserted. A direction along an axial direction of that insertion hole is a longitudinal direction of the connector housing, and a direction orthogonal to the longitudinal direction is a lateral direction. If the connector housings are arranged laterally side by side in the first long body, the insertion holes for the insertion of the terminals are open in a width direction of the first long body. Therefore, as described in embodiments later, the terminals can be successively inserted into the connector housings without cutting the connector housings off from the first long body.

<3> As one form of the connector housing storage structure according to the embodiment, each of the plurality of connector housings includes a terminal held inside.

If the terminal is held in the connector housing in advance, the damage of the terminal can be suppressed when the connector housing is mounted on the end part of the communication cable. By storing the terminal in the connector housing, the terminal is less likely to be damaged than in the case where a plurality of terminals are stored in one container.

Further, if the terminal is held in the connector housing in advance, an operation of mounting the connector member on the end part of the communication cable is facilitated. In this operation, the first long body is fed from the first reel and the tip of the communication cable is inserted into the terminal of each connector housing provided in the first long body. Here, since the connector housings are linked by the first carrier, the orientations of the connector housings to be successively supplied to the work location are aligned. Further, the connector housings linked to the first long body do not fall and the terminals held in the connector housings also do not fall. Therefore, the tip of the communication cable is easily inserted into the terminal of the connector housing.

<4> As one form of the connector housing storage structure described in <3> above, the terminal includes a wire barrel, and each of the plurality of connector housings includes a through hole provided at a position where the wire barrel is arranged.

The wire barrel is connected to a conductor of the communication cable, for example, by crimping. The through hole formed in the connector housing functions as a work space into which a tool or the like is inserted in connecting the wire barrel and the conductor. Therefore, even if the terminal is held in each connector housing provided in the first long body in advance, an operation of connecting that terminal and the conductor of the communication cable is easily performed.

<5> As one form of the connector housing storage structure described in <3> or <4> above, the terminal includes an engaging claw, and each of the plurality of connector housings includes an engaging recess to be locked by the engaging claw.

The terminal needs to be fixed to the connector member. If the terminal is formed with the engaging claw and the connector member is formed with the engaging recess corresponding to the engaging claw, the terminal and the connector member are firmly fixed.

Further, by providing the engaging claw having a more complicated shape than the engaging recess on the side of the terminal, the configuration of the connector member is simplified. Therefore, the connector member can be reduced in size by forming the terminal with the engaging claw.

<6> A connector cover storage structure according to the embodiment is a connector cover storage structure for storing a connector cover constituting a connector member to be provided on an end part of a communication cable and includes a second long body and a second reel, the second long body being wound on the second reel, wherein the second long body includes a plurality of connector covers and a second carrier linking the plurality of connector covers into one.

According to the connector cover storage structure of the embodiment, the connector covers do not fiercely collide with each other during the storage/transportation of the connector covers. This is because the connector covers are held by the second carrier. Therefore, the connector cover storage structure of the embodiment can suppress the damage of the connector covers, such as during storage.

According to the connector cover storage structure of the embodiment, the connector covers can be efficiently supplied to the work location. This is because the connector covers can be supplied to the work location only by feeding the second long body from the second reel toward the work location. Further, since the connector covers provided in the second long body are linked by the second carrier, the orientations of the connector covers to be supplied to the work location are aligned. Therefore, the connector cover is easily mounted on the connector housing.

### Details of Embodiments of Present Disclosure

Hereinafter, specific examples of a connector housing storage structure and a connector cover storage structure according to embodiments of the present disclosure are described on the basis of the drawings. In figures, the same reference signs denote the same components. Note that the present invention is not limited to these illustrations and is intended to be represented by claims and include all changes in the scope of claims and in the meaning and scope of equivalents.

### First Embodiment

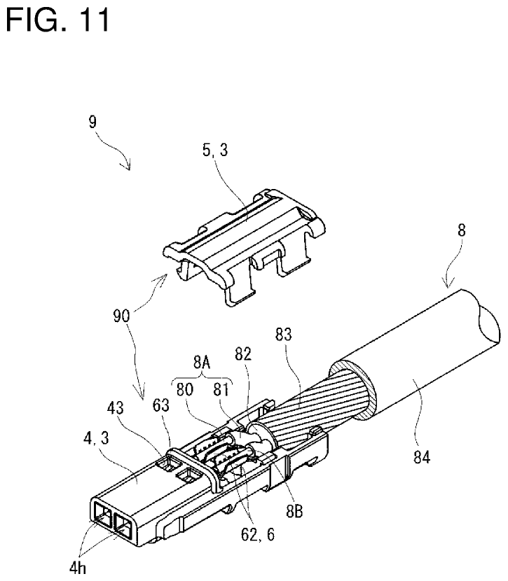

Prior to the description of the connector housing storage structure and the connector cover storage structure of this example, a communication cable with connector in which a connector housing and a connector cover are used is described on the basis of FIG. 11.

<Communication Cable with Connector>

A communication cable with connector 9 shown in FIG. 11 includes a communication cable 8 and a connector module 90 provided on an end part of the communication cable 8. The connector module 90 includes a connector member 3 and terminals 6 arranged inside the connector member 3. The communication cable with connector 9 of this example is a pigtail cable having the connector module 90 provided on one end of the communication cable 8. Unlike this example, the communication cable with connector 9 may be a jumper cable provided with the connector modules 90 on both ends of the communication cable 8.

Communication Cable

The communication cable 8 is a twisted pair cable satisfying Ethernet (registered trademark) standards. The twisted pair cable is suitable for differential communication less susceptible to noise.

The communication cable 8 includes two twisted wires 8A, 8B. The wire 8A, 8B includes a conductor 80 and a conductor insulation layer 81 for covering the outer periphery of the conductor 80. The two twisted wires 8A, 8B are gathered into one by an interposed insulation layer 82. The communication cable 8 further includes a shielding layer 83 provided on the outer periphery of the interposed insulation layer 82 and a sheath 84 for covering the outer periphery of the shielding layer 83. The shielding layer 83 is for shielding electromagnetic waves and, for example, formed by a braided wire made of aluminum alloy. On the other hand, the sheath 24 is made of insulating resin such as polyvinyl chloride or polyethylene.

Terminal

The terminal of this example is a female terminal. The terminal 6 may be a male terminal. The terminal 6 includes a wire barrel 62 for gripping the conductor 80 of the communication cable 8. Although the wire barrel 62 is shown in an open state in FIG. 11, the wire barrel 62 is actually in a closed state. The detailed configuration of the terminal 6 is described later.

Connector Member

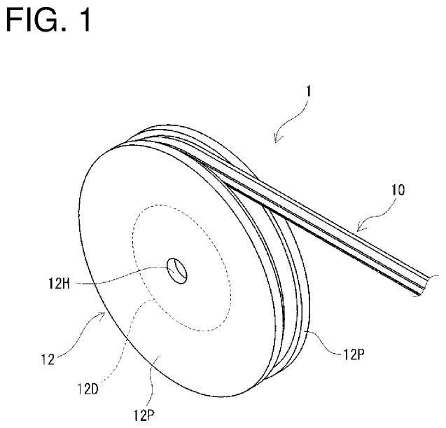

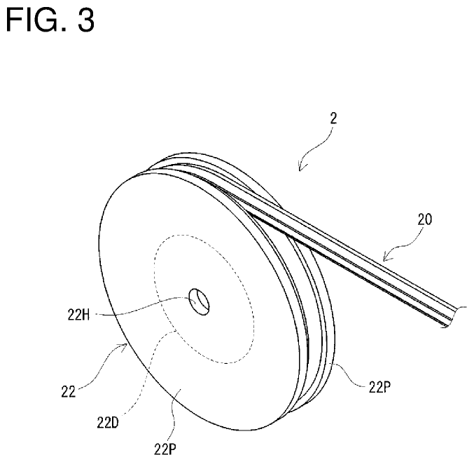

The connector member 3 of this example constituting the connector module 90 includes a connector housing 4 and a connector cover 5. Both the connector housing 4 and the connector cover 5 are made of insulating resin such as polyethylene. In this example, the connector housing 4 and the connector cover 5 are respectively stored by a connector housing storage structure 1 shown in FIG. 1 and a connector cover storage structure 2 shown in FIG. 3. Hereinafter, the respective storage structures 1, 2 are described and the structures of the connector housing 4 and the connector cover 5 are also mentioned.

<<Connector Housing Storage Structure>>

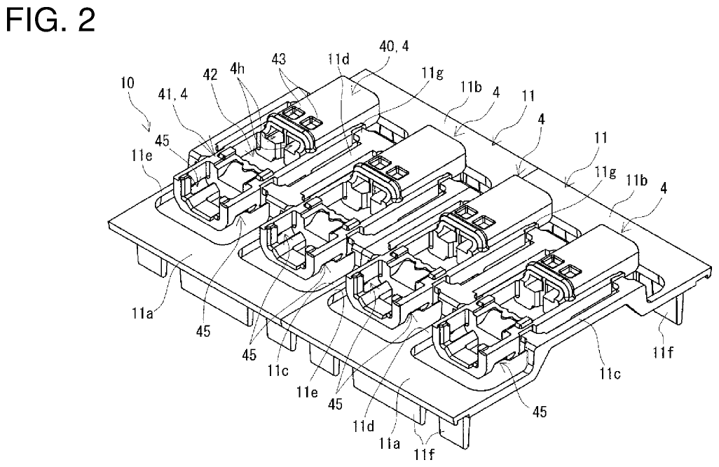

The connector housing storage structure 1 shown in FIG. 1 is a structure for storing the connector housings 4 (FIG. 2). This storage structure 1 is provided with a first long body 10 including a plurality of the connector housings 4 and a first reel 12 on which the first long body 10 is wound.

First Reel

First, the configuration of the first reel 12 is described. The first reel 12 includes a winding drum 12D and two disk-shaped plates 12P, 12P. One plate 12P is arranged on one end side in an axial direction of the winding drum 12D, and the other plate 12P is arranged on the other end side in the axial direction of the winding drum 12D. The first long body 10 is wound on the winding drum 12D several turns and stored in a space between the two plates 12P, 12P. A reel hole 12H is provided in a center of the winding drum 12D. Thus, the first reel 12 is configured to be rotatable about a rotary shaft inserted into the reel hole 12H.

First Long Body

As shown in FIG. 2, the first long body 10 is formed by linking the plurality of connector housings 4 by first carriers 11. In this example, the connector housings 4 are linked laterally side by side by the first carriers 11. The plurality of connector housings 4 are all oriented in the same direction.

The first long body 10 of this example is fabricated by linking a plurality of resin molded bodies serving as molding units. A state where two resin molded bodies are integrated is shown in FIG. 2. Each resin molded body includes two connector housings 4, 4 as products, and a plurality of frame pieces 11a, 11b, 11c, 11d and 11e linking those connector housings 4, 4. The frame pieces 11a, 11b are longitudinal pieces extending in an extending direction of the first long body 10. The frame pieces 11c, 11d and 11e are transverse pieces linking the frame pieces 11a and 11b. One connector housing 4 is arranged in a space surrounded by the frame pieces 11a, 11b, 11c and 11d. Further, another connector housing 4 is arranged in a space surrounded by the frame pieces 11a, 11b, 11d and 11e. How many connector housings 4 are included in one resin molded body may be appropriately determined in consideration of the flexibility of the first long body 10. For example, three or more connector housings 4 may be included in one resin molded body.

In the case of linking the two resin molded bodies described above, the resin molded body on a left side in FIG. 2 is formed after the resin molded body on a right side in FIG. 2 is formed. Here, when the resin molded body on the left side is molded by a mold, a part of the frame piece 11e, which is a left side edge part of the resin molded body on the right side, is inserted in that mold. That is, when the resin molded body on the left side is molded, a part of the frame piece 11e of the resin molded body on the right side is molded again. As a result, a joint of the both resin molded bodies is melted to link the both resin molded bodies. If this operation is continuously performed, the first long body 10 of this example can be fabricated.

Connector Housing

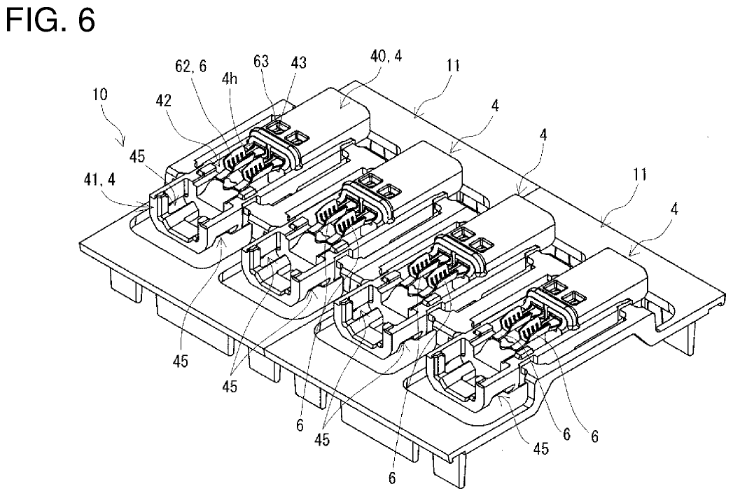

The connector housing 4 includes a connector tube portion 40 (FIG. 2), into which the tips of the terminals 6 (FIG. 6) are inserted, and a base portion 41 (FIG. 2) supporting connected parts (FIG. 11) of the terminals 6 and the conductors 80. An upper side of the base portion 41 is open.

The connector tube portion 40 includes a pair of insertion holes 4h (see also FIG. 11) into which the terminals 6 are inserted. The connector tube portion 40 is provided with engaging recesses 43 (engaging holes) communicating with the insertion holes 4h from the outer peripheral surface thereof. The engaging recesses 43 may be recesses formed in the inner peripheral surfaces of the insertion holes 4h. Engaging claws 63 (FIG. 11) of the terminals 6 are engaged with these engaging recesses 43.

The base portion 41 is further provided with a housing-side engaging portion 45 and a through hole 42 (FIG. 2). The housing-side engaging portion 45 is used to couple the connector housing 4 and the connector cover 5. The housing-side engaging portion 45 of this example is constituted by an engaging hole penetrating through the base portion 41. On the other hand, the through hole 42 is provided at a position corresponding to the connected parts of the terminals 6 and the conductors 80 shown in FIG. 11. The through hole 42 is provided to facilitate an operation of connecting the terminals 6 and the conductors 80. This through hole 42 doubles as the housing-side engaging portion 45. Unlike this example, the housing-side engaging portion 45 may be an engaging claw.

First Carrier

The first carrier 11 is configured by connecting the aforementioned frame pieces 11a, 11b, 11c, 11d and 11e, which are resin molded bodies. In this example, the frame piece 11d is a runner, and the runner 11d includes a gate 11g and an unillustrated sprue. The number of the gates 11g is appropriately selected depending on molding conditions.

The frame pieces 11a, 11b of the first carrier 11 include a plurality of reinforcing portions 11f projecting in a thickness direction thereof. The reinforcing portions 11f are plate-like pieces extending along the extending direction of the first long body 10. Excessive bending of the frame pieces 11a, 11b is suppressed by the reinforcing portions 11f. Further, the reinforcing portions 11f function to ensure a distance between different turns when the first long body 10 is wound on the first reel 12 (FIG. 1) several turns. For example, the reinforcing portions 12f in the n^{th} turn are in contact with the upper surfaces of the frame pieces 11a, 11b in the n−1^{th} turn. As a result, a distance between the n^{th} turn and the n−1^{th} is ensured by a projection length of the reinforcing portions 11f. The projection length of the reinforcing portions 11f is preferably so set that the connector housings 4 in the n^{th} turn and the connector housings 4 in the n−1^{th} turn do not contact. Here, n is an arbitrary natural number equal to or greater than 2.

According to the connector housing storage structure 1 of this example, the connector housings 4 do not fiercely collide with each other during the storage/transportation of the connector housings 4. This is because the connector housings 4 are held by the first carrier 11. Therefore, the connector housing storage structure 1 can suppress the damage of the connector housings 4, such as during storage.

According to the connector housing storage structure 1 of this example, the connector housings 4 can be efficiently supplied to a work location where the connector housing 4 is mounted on the end part of the communication cable 8 (FIG. 11). This is because the connector housings 4 can be supplied to the work location only by feeding the first long body 10 from the first reel 12 to the work location. Further, since the connector housings 4 provided in the first long body 10 are linked by the first carriers 11, the orientations of the connector housings 4 to be supplied to the work location are aligned. Therefore, the connector housing 4 is easily mounted on the end part of the communication cable 8 (FIG. 11).

<<Connector Cover Storage Structure>>

The connector cover storage structure 2 shown in FIG. 3 is a structure for storing the connector covers 5 (FIG. 11). This storage structure 2 includes a second long body 20 including a plurality of the connector covers 5 and a second reel 22 on which the second long body 20 is wound.

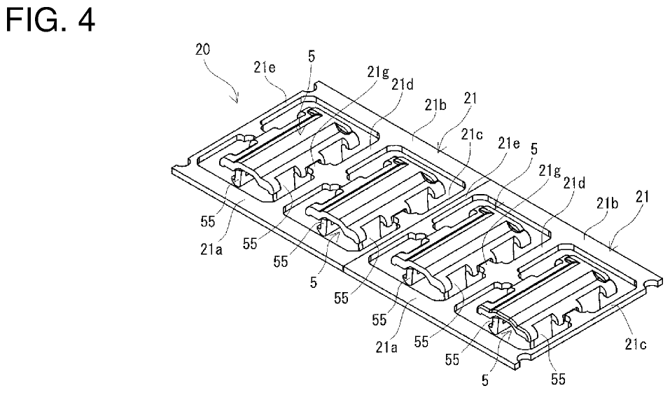

As shown in FIG. 4, the second long body 20 of this example is also fabricated by linking a plurality of resin molded bodies serving as molding units, similarly to the first long body 10. A state where two resin molded bodies are integrated is shown in FIG. 4. The resin molded body of the second long body 20 includes two connector covers 5, 5 as products, and a plurality of frame pieces 21a, 21b, 21c, 21d and 21e linking those connector covers 5, 5. The frame pieces 21a, 21b are longitudinal pieces extending in an extending direction of the second long body 20, and the frame pieces 21c, 21d and 21e are transverse pieces linking the frame pieces 21a and 21b. A fabrication method of the second long body 20 is similar to that of the first long body 10.

Second Reel

A basic configuration of the second reel 22 is the same as that of the first reel 12 of FIG. 1. Accordingly, the second reel 22 includes a winding drum 22D and two disk-shaped plates 22P, 22P. The second long body 20 is wound on the winding drum 22D several turns and stored in a space between the two plates 22P, 22P. The second reel 22 is configured to be rotatable about a rotary shaft inserted into a reel hole 22h of the winding drum 22D.

Second Long Body

As shown in FIG. 4, the second long body 20 is formed by linking the plurality of connector covers 5 by second carriers 21. In this example, the connector covers 5 are linked laterally side by side by the second carriers 21. The plurality of connector covers 5 are all oriented in the same direction.

Connector Cover

The connector cover 5 is a member for covering an opening of the base portion 41 in the connector housing 4 shown in FIG. 2. The connector cover 5 is provided with a plurality of cover-side engaging portions 55. The cover-side engaging portions 55 of this example are engaging claws to be fit into the housing-side engaging portion 45 (FIG. 2) formed by an engaging hole. By the engagement of the engaging claws and the engaging hole, the connector cover 5 is firmly fixed to the connector housing 4. Here, if the housing-side engaging portion 45 (FIG. 2) is constituted by an engaging claw, the cover-side engaging portion 55 may be an engaging hole.

Second Carrier

The second carrier 21 includes sprues (not shown) and gates 21g in addition to the aforementioned frame pieces 21a, 21b, 21c, 21d and 21e. Further, the frame pieces 21a, 21b may be provided with a plurality of unillustrated reinforcing portions. The reinforcing portions have the same function as the reinforcing portions 11f of the first carrier 11 (FIG. 2). Accordingly, a projection length of the reinforcing portions is preferably so set that the connector covers 5 in the n^{th} turn and those in the n−1^{th} turn do not contact each other.

According to the connector cover storage structure 2 of this example, the connector covers 5 do not fiercely collide with each other during the storage/transportation of the connector covers 5. This is because the connector covers 5 are held by the second carriers 21. Therefore, the connector cover storage structure 2 of this embodiment can suppress the damage of the connector covers 5, such as during storage.

According to the connector cover storage structure 2 of this example, the connector covers 5 can be efficiently supplied to the work location. This is because the connector covers 5 can be supplied to the work location only by feeding the second long body 20 from the second reel 22 to the work location. Further, since the connector covers 5 provided in the second long body 20 are linked by the second carriers 21, the orientations of the connector covers 5 to be supplied to the work location are aligned. Therefore, the connector cover 5 is easily mounted on the connector housing 4.

<<Mounting Procedure of Connector Module on Communication Cable>>

A mounting procedure of the connector module 90 on the communication cable 8 (FIG. 11) is described below mainly with reference to FIGS. 4 to 10.

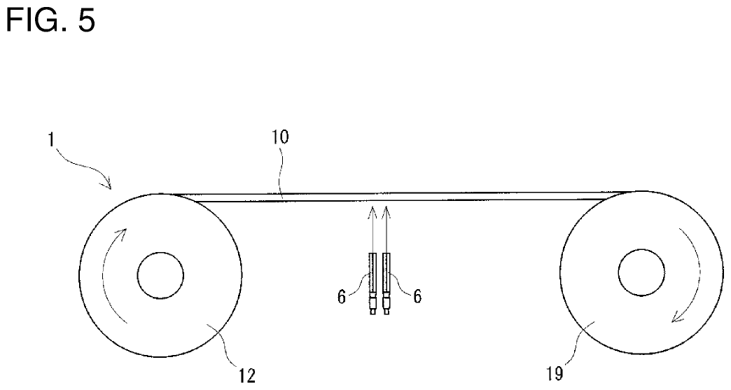

As shown in FIG. 5, the first long body 10 is fed from the first reel 12 of the connector housing storage structure 1 on a left side and is wound on another first reel 19 on a right side. The terminals 6 are mounted into the connector housings 4 provided in the first long body 10 between the first and second reels 12 and 19. The configuration of the first reel 19 is similar to that of the first reel 12 of FIG. 1.

The terminals 6 are preferably supplied for a step shown in FIG. 5 without being stored in a container or the like after being press-molded. By so doing, the terminals 6 can be protected by the connector housings 4 and a risk of damaging the terminals 6 can be reduced. That is, the connector housings 4 function as storage members for the terminals 6.

FIG. 6 is a partial enlarged view of the first long body 10 wound on the first reel 19. As shown in FIG. 6, the tips of the terminals 6 are inserted in the insertion holes 4h (see FIG. 2) of the connector housings 4 in the first long body 10 wound on the first reel 19 (FIG. 5). The engaging claw 63 provided in the terminal 6 is engaged with the engaging recess 43 of the connector housing 4. As a result, the terminal 6 is held in the connector housing 4.

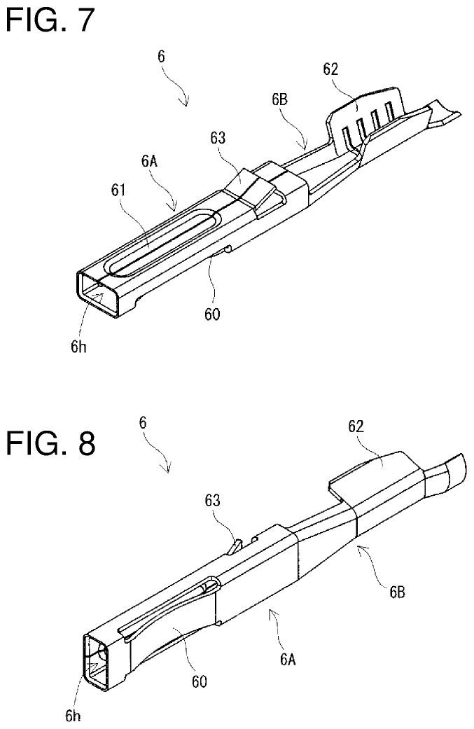

Here, the configuration of the terminal 6 of this example is described on the basis of FIGS. 7 and 8. The terminal 6 of this example is a female terminal. The terminal 6 is fabricated by press-molding a plate material. The terminal 6 includes a tubular portion 6A and a connecting portion 6B. The tubular portion 6A includes a terminal hole 6h into which an unillustrated male terminal is inserted. The terminal 6 and the male terminal are electrically connected by the mechanical contact of the terminal 6 and the male terminal.

The tubular portion 6A includes a leaf spring portion 60 for pressing the outer peripheral surface of the male terminal inserted into the terminal hole 6h. An outer part of this leaf spring portion 60 is exposed on the outer periphery of the tubular portion 6A. As shown in FIG. 8, the leaf spring portion 60 is constituted by a part of the tubular portion 6A. Specifically, a part of the lower surface of the tubular portion 6A in the form of a rectangular tube constitutes the leaf spring portion 60. An end part of the leaf spring portion 60 on the side of the terminal hole 6h and an end part thereof on the side of the connecting portion 6B are linked to the tubular portion 6A. The lower surface of the tubular portion 6A is a surface facing forward in FIG. 8. On the other hand, two corner parts of the tubular portion 6A on opposite sides of the leaf spring portion 60 are punched out. A center of the leaf spring portion 60 in an axial direction of the tubular portion 6A is curved inwardly of the tubular portion 6A. The axial direction of the tubular portion 6A is a direction along which the male terminal is inserted and withdrawn. Such a leaf spring portion 60 is easily fabricated by press-molding. For example, the leaf spring portion 60 is formed only by punching out some of parts serving as corner parts of the tubular portion 6A, out of the plate material from which the terminal 6 is formed, and fabricating the tubular portion 6A by press-molding.

A pressing portion 61 recessed toward the inside of the tubular portion 6A is provided on a surface of the tubular portion 6A opposite to the leaf spring portion 60. The pressing portion 61 presses the male terminal accommodated into the tubular portion 6A toward the leaf spring portion 60. As a result, the contact of the male terminal and the leaf spring portion 60 is reliably ensured. The pressing portion 61 of this example is also exposed on the outer periphery of the tubular portion 6A. Since nothing covers the pressing portion 61 from outside, the pressing portion 61 can be simultaneously formed when the tubular portion 6A is press-molded.

The connecting portion 6B is a part to be electrically connected to the conductor 80 (FIG. 11). This connecting portion 6B is provided with the wire barrel 62. The wire barrel 62 is a member for gripping the conductor 80. Here, the terminal 6 of this example includes only the wire barrel 62 as a barrel for gripping the outer periphery of the communication cable 8. A conventional terminal includes an insulation barrel for gripping the sheath 84 of the communication cable 8, but the terminal 6 of this example includes no insulation barrel.

The terminal 6 includes the engaging claw 63 to be engaged with the engaging recess 43 of the connector member 3 (FIG. 6). The engaging claw 63 is formed by forming a cut in a part of the plate material constituting the terminal 6 and bending the cut part. Thus, the engaging claw 63 serves as a leaf spring. The tip of the engaging claw 63 is facing toward the wire barrel 62. The terminal 6 is inserted into the insertion hole 4h of the connector housing 4 (FIG. 6). More specifically, the terminal 6 is inserted into the insertion hole 4h from the side of the base portion 41 of the connector housing 4 shown in FIG. 6. When the terminal 6 is inserted into the insertion hole 4h, the engaging claw 63 is deformed toward the inside of the tubular portion 6A. The engaging claw 63 returns to an initial shape by its own resilience at a position corresponding to the engaging recess 43. The engaging claw 63 is caught in the engaging recess 43 and the terminal 6 is firmly fixed to the connector housing 4.

A thickness of each part of the terminal 6 is preferably 0.15 mm or less. If the thickness of each part of the terminal 6 is 0.15 mm or less, the terminal 6 is easily reduced in size. Further, the thickness of each part of the terminal 6 is preferably 0.05 mm or more. If this thickness is 0.05 mm or more, the strength of the terminal 6 is ensured. A more preferable thickness of each part of the terminal 6 is 0.075 mm or more and 0.13 mm or less. An even more preferable thickness of each part of the terminal 6 is 0.080 mm or more and 0.10 mm or less. The thickness mentioned here does not include a thickness of an edge formed by bending the plate material constituting the terminal 6.

The terminal 6 is made of a material excellent in conductivity. Here, the terminal 6 includes no protecting portion for covering the outer periphery of the leaf spring portion 60 unlike conventional female terminals. Thus, the terminal 6 of this example is preferably made of a material excellent in strength. An example of the material excellent in conductivity and strength is stainless steel. Stainless steels preferable for the terminal 6 of this example are, for example, 1.4372, 1.4373, 1.4310, 1.4318, 1.4305, 1.4307, 1.4306, 1.4311, 1.4303, 1.4401, 1.4436, 1.4404, 1.4432, 1.4435, 1.4406, 1.4429, 1.4571, 1.4438, 1.4434, 1.4439, 1.4539, 1.4541, 1.4550, 1.4587, 1.4381, 1.4462, 1.4507 and 1.4002 in European standards. Among these, 1.4310 and 1.4318 are, for example, preferable in terms of conductivity and strength. The surface of the terminal 6 is preferably plated with a material excellent in conductivity. A plating material is, for example, tin (Sn) or silver (Ag).

The terminal 6 configured as described above has a very simple configuration. Particularly, since the terminal 6 has no configuration for covering the leaf spring portion 60 and the pressing portion 61 from outside, the leaf spring portion 60 and the pressing portion 61 can be simultaneously fabricated when the tubular portion 6A is press-molded. Accordingly, the terminal 6 of this example can be more easily fabricated than conventional female terminals. As shown in FIG. 5, the terminals 6 of this example are held in the connector housing 4 immediately after being press-molded. Thus, the terminals 6 are protected by the connector housing 4, wherefore the terminals are hardly damaged even if having a simple configuration as shown in this example.

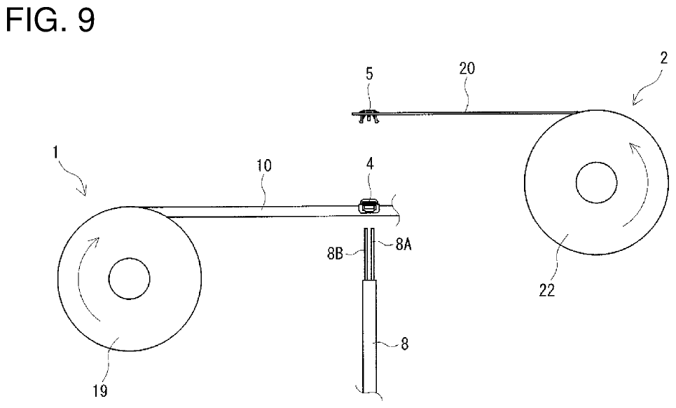

Next, the procedure of mounting the connector member 3 on the end part of the communication cable 8 is described with reference to FIG. 9. As shown in FIG. 9, the first long body 10 is fed from the first reel 19 toward a work location in a center of FIG. 9. The end part of the communication cable 8, i.e. the end parts of the wires 8A, 8B are inserted into the connector housing 4 of the first long body 10. Although the end part of the communication cable 8 approaches the connector housing 4 from below in FIG. 9, the end part of the communication cable 8 actually approaches the connector housing 4 from a front side to a back side of the plane of FIG. 9. Since the connector housings 4 are linked by the first carriers 11, the orientations of the connector housings 4 to be supplied to the work location are aligned. Particularly, since the connector housings 4 are linked laterally side by side in this example, the end part of the communication cable 8 is caused to approach from a side lateral to the first long body 10. Therefore, the connector housing 4 is easily mounted on the end part of the communication cable 8.

The end parts of the communication cables 8 are successively inserted into the connector housings 4. Accordingly, the connector housings 4 are efficiently mounted on the end parts of the communication cables 8. After the end part of the communication cable 8 is inserted into the connector housing 4, the wire barrels 62 of the terminals 6 and the conductors 80 of the communication cable 8 are connected.

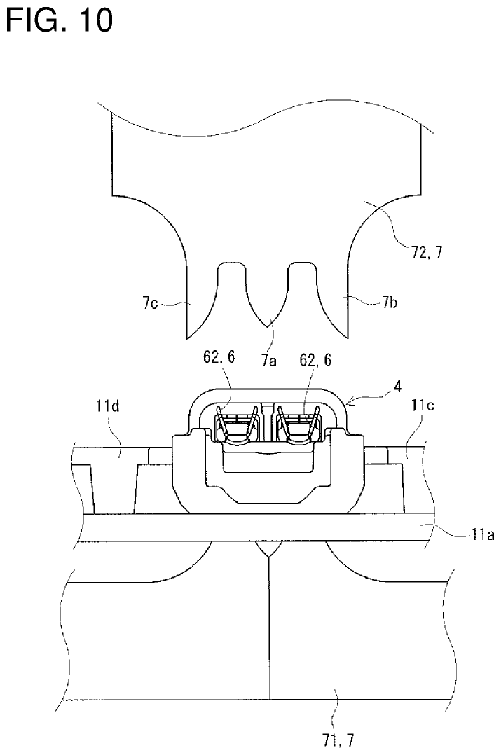

A mounting tool 7 shown in FIG. 10 is used to connect the wire barrels 62 of the terminals 6 and the conductors 80. The mounting tool 7 includes an anvil 71 for supporting the wire barrels 62 from below when the wire barrels 62 are processed and a crimper 72 for crimping the wire barrels 62. The crimper 72 includes three claw portions 7a, 7b and 7c. The middle claw portion 7a has a substantially constant width from the base end thereof to an intermediate part and a width thereof is reduced from the intermediate part to a tip part. On the other hand, out of the claw portions 7b, 7c on both sides, parts facing the claw portion 7a are shaped to be gradually separated from the claw portion 7a from the base ends toward tip parts of the claw portions 7b, 7c. According to the mounting tool 7 having a such a shape, the wire barrels 62, 62 can be simultaneously crimped to two conductors 80 (FIG. 11).

In the case of crimping the wire barrels 62 to the conductors 80 (FIG. 11) using the mounting tool 7, the tip of the anvil 71 is inserted into the through hole 42 (FIG. 6). The tip of the anvil 71 comes into contact with the lower surfaces of the wire barrels 62 through the through hole 42. After the conductors 80 (FIG. 11) are arranged in the wire barrels 62, the crimper 72 is moved toward the anvil 71. The wire barrel 62 on a right side is sandwiched and crimped by the claw portions 7a, 7b and the wire barrel 62 on a left side is sandwiched and crimped by the claw portions 7a, 7c. As a result, the wire barrels 62 are crimped to the conductors 80 (FIG. 11). Here, if the anvil 71 is provided with a pressure sensor, the wire barrels 62 can be crimped with an optimal pressure based on a measurement result of the pressure sensor.

The second long body 20 is fed from the second reel 22 to the above work location shown in FIG. 9. The connector cover 5 provided in the second long body 20 is cut off from the second carrier 21 (FIG. 4) near the work location and mounted on the connector housing 4. The connector housing 4 having the connector cover 5 mounted thereon is cut off from the first carrier 11 (FIG. 2) near the work location. As a result, the connector module 90 (FIG. 11) is mounted on the end part of the communication cable 8. Since the connector covers 5 provided in the second long body 20 are linked by the second carriers 21, the orientations of the connector covers 5 to be supplied to the work location are aligned. Therefore, the connector covers 5 are easily mounted on the connector housings 4.

The mounting operation described above may be performed by a human or may be automatically performed by an industrial robot. In either case, the efficiency of the mounting operation is very excellent. This is because the connector housings 4 and the connector covers 5 are successively supplied from the storage structures 1, 2 of this example and the orientations of the connector housings 4 and the connector covers 5 are aligned.

### Second Embodiment

In the first embodiment, the terminals and the conductors of the communication cable are connected after the terminals are inserted into the connector housing. In contrast, the terminals may be inserted into the connector housing after the terminals and conductors of the communication cable are connected.

### LIST OF REFERENCE NUMERALS

1 connector housing storage structure

10 first long body

11 first carrier

11a, 11b, 11c, 11d, 11e frame piece, 11f reinforcing portion, 11g gate

12, 19 first reel, 12D winding drum, 12H reel hole, 12P plate

2 connector cover storage structure

20 second long body

21 second carrier

21a, 21b, 21c, 21d, 21e frame piece, 21g gate

22 second reel, 22D winding drum, 22H reel hole, 22P plate

3 connector member

4 connector housing

4h insertion hole

40 connector tube portion, 41 base portion

42 through hole, 43 engaging recess, 45 housing-side engaging portion

5 connector cover

55 cover-side engaging portion

6 terminal

6A tubular portion, 6B connecting portion, 6h terminal hole

60 leaf spring portion, 61 pressing portion, 62 wire barrel, 63 engaging claw

7 mounting tool

7a, 7b, 7c claw portion

71 anvil, 72 crimper

8 communication cable

8A, 8B wire

80 conductor, 81 conductor insulation layer, 82 interposed insulation layer

83 shielding layer, 84 sheath

9 communication cable with connector

90 connector module

1. A connector housing storage structure for storing a connector housing constituting a connector member to be provided on an end part of a communication cable, comprising:
a first long body; and
a first reel, the first long body being wound on the first reel,
wherein:
the first long body includes a plurality of connector housings and a first carrier linking the plurality of connector housings into one,
the plurality of connector housings and the first carrier are integrated into a resin molded article, and
the first carrier includes a plurality of frame pieces individually surrounding each of the plurality of connector housings.

2. The connector housing storage structure according to claim 1, wherein the plurality of connector housings are linked laterally side by side by the first carrier.

3. The connector housing storage structure according to claim 1, wherein each of the plurality of connector housings includes a terminal held inside.

4. The connector housing storage structure according to claim 3, wherein:
the terminal includes a wire barrel, and
each of the plurality of connector housings includes a through hole provided at a position where the wire barrel is arranged.

5. The connector housing storage structure according to claim 3, wherein:
the terminal includes an engaging claw, and
each of the plurality of connector housings includes an engaging recess to be locked by the engaging claw.

6. A connector cover storage structure for storing a connector cover constituting a connector member to be provided on an end part of a communication cable, comprising:
a second long body; and
a second reel, the second long body being wound on the second reel,
wherein the second long body includes a plurality of connector covers and a second carrier linking the plurality of connector covers into one,
the plurality of connector covers and the second carrier are integrated into a resin molded article, and
the second carrier includes a plurality of frame pieces individually surrounding each of the plurality of connector covers.
